(19) United States
(12) Patent Application Publication
(10) Pub. No.: US 2015/0266026 A1
(43) Pub. Date: Sep. 24, 2015

(54) PLATE-LIKE MEMBER FOR PIPETTE TIPS, PIPETTE TIP, LIQUID AGITATION KIT AND LIQUID AGITATION APPARATUS

(71) Applicant: Sony Corporation, Tokyo (JP)

(72) Inventor: Yoichi Katsumoto, Tokyo (JP)

(73) Assignee: Sony Corporation, Tokyo (JP)

(21) Appl. No.: 14/644,599

(22) Filed: Mar. 11, 2015

(30) Foreign Application Priority Data
Mar. 18, 2014 (JP) 2014-055036

(51) Int. Cl. B01L 9/00; B01L 3/02

(52) U.S. Cl. CPC B01L 9/543; B01L 3/0275; B01L 2300/0803

(57) ABSTRACT

There is provided a plate-like member for pipette tips including a pipette tip insertion hole disposed on a first plane, one or a plurality of communicating holes that is disposed on a second plane as a back face of the first plane and that communicates with the pipette tip insertion hole, and one or a plurality of flow passages through which a liquid discharged from a pipette tip inserted into the pipette tip insertion hole flows from the second plane side to the first plane side.

### CROSS REFERENCE TO RELATED APPLICATIONS

This application claims the benefit of Japanese Priority Patent Application JP 2014-055036 filed Mar. 18, 2014, the entire contents of which are incorporated herein by reference.

### BACKGROUND

The present technology relates to a plate-like member for pipette tips, a pipette tip, a liquid agitation kit and a liquid agitation apparatus. More particularly, the present technology relates to a technology of agitating a liquid by pipette operation.

In areas of biochemistry or the like, various pipettes are widely used for dispensing a solution or a liquid sample. Some pipette is of the type in which a replaceable component is used in the portion that comes into contact with a liquid. This replaceable component is called a “pipette tip”. When dispensing a liquid using such a pipette, the liquid discharged from the pipette tip is sucked again into the pipette tip, and sucking and discharging are repeated, thereby to agitate the liquid. However, when the sucking and discharging were simply repeated using such a pipette, agitation of the liquid was sometimes insufficient.

With respect to the above-described problem that agitation is insufficient, JP 2011-107089A discloses “a liquid mixing method comprising agitating two different liquids to obtain a mixed liquid, wherein after supplying a container containing a first liquid with a second liquid, a total amount of the liquids are not sucked, and air is introduced into a distal end portion of a pipette tip during sucking to allow air bubbles to be generated during discharging, and sucking and discharging are repeated for performing agitation”. This method enables agitation to be efficiently performed by introducing air into a distal end portion of a pipette tip while sucking a liquid, allowing air bubbles to be generated while discharging the liquid to swing the air bubbles by the discharged liquid, and repeating the sucking and discharging.

### SUMMARY

According to the liquid mixing method described in JP 2011-107089A, a liquid can be effectively agitated. However, even when the method disclosed in JP 2011-107089A described above is used, the conventional sucking and discharging may be necessary to be repeated in order to achieve a state where a liquid is sufficient agitated. For this reason, it may be necessary to perform the agitation of a liquid more simply.

Therefore, it is desired to provide a member configured to agitate a liquid poured in a container using a pipette.

According to an embodiment of the present disclosure, there is provided a plate-like member for pipette tips including a pipette tip insertion hole disposed on a first plane, one or a plurality of communicating holes that is disposed on a second plane as a back face of the first plane and that communicates with the pipette tip insertion hole, and one or a plurality of flow passages through which a liquid discharged from a pipette tip inserted into the pipette tip insertion hole flows from the second plane side to the first plane side.

The pipette tip insertion hole may extend through the communicating holes to the second plane side.

Further, the pipette tip insertion hole may be disposed in a center in a planar view, and the flow passages may be through holes.

In addition, an edge may be notched in a spreading direction of the plate-like member for pipette tips with a shape of a polygon, a circle or a combination of a polygon and a circle.

The liquid may contain at least one selected from cells, proteins, polysaccharides, alcohols, surfactants and synthetic polymers, and the liquid may be a biological sample.

According to another embodiment of the present disclosure, there is provided a pipette tip including the plate-like member for pipette tips. An inner diameter of the pipette tip insertion hole may be formed with a size that allows a distal end of the pipette tip to project from the communicating hole in a state where the pipette tip is inserted, and the plate-like member for pipette tips and the pipette tip may be integrally molded.

According to another embodiment of the present disclosure, there is provided a liquid agitation kit including the plate-like member for pipette tips according to claim 1, and a container that contains a liquid discharged from the pipette tip. The plate-like member for pipette tips may have a cross section similar to a cross section of a space where the liquid is contained in the container.

According to another embodiment of the present disclosure, there is provided a liquid agitation apparatus including the plate-like member for pipette tips, a pipette tip that is inserted into the pipette tip insertion hole, a container that contains a liquid discharged from the pipette tip, and a pipette controller that controls discharging of the liquid from the pipette tip. The liquid agitation apparatus may further include a drive mechanism that changes a relative position in a vertical direction between the pipette tip and the container.

According to the present disclosure, there is provided a member configured to agitate a liquid poured in a container using a pipette, and the like. It is noted that the effects described herein are not necessarily limiting, and any one of the effects described in the present disclosure may be exerted.

### BRIEF DESCRIPTION OF THE DRAWINGS

FIG. 1 is a schematic view illustrating an example of a liquid agitation apparatus according to a first embodiment of the present disclosure;

FIG. 2 is a perspective view of the pipette tip and the plate-like member for pipette tips illustrated in FIG. 1;

FIG. 3A is a plan view of a pipette tip and a plate-like member for pipette tips, FIG. 3B is a cross-sectional diagram along P-P line of FIG. 3A, and FIG. 3C is a cross-sectional diagram when a pipette tip and a plate-like member for pipette tips are integrally molded;

FIGS. 4A to 4D are each a schematic cross-sectional view illustrating a configuration example of a pipette tip and a plate-like member for pipette tips;

FIGS. 5A to 5C are each a schematic plan view illustrating a configuration example of a plate-like member for pipette tips;

FIGS. 6A and 6B are each a schematic plan view illustrating a configuration example of a plate-like member for pipette tips;

FIGS. 7A to 7C are each a schematic plan view illustrating a configuration example of a plate-like member for pipette tips;

FIG. 8A is a plan view of a plate-like member for pipette tips, FIG. 8B is a cross-sectional diagram along Q1-Q1 line of FIG. 8A, FIG. 8C is a plan view of a container, and FIG. 8D is a cross-sectional diagram along Q2-Q2 line of FIG. 8C;

FIGS. 9A to 9D are each a diagram illustrating a general outline for agitation of a liquid by a liquid agitation apparatus; and

FIG. 10 is a schematic view illustrating an example of a liquid agitation apparatus according to a second embodiment of the present disclosure.

### DETAILED DESCRIPTION OF THE EMBODIMENT(S)

Hereinafter, preferred embodiments for implementing the present disclosure will be described. It is noted that the embodiments described below are exemplary embodiments of the present disclosure, and do not cause the scope of the present disclosure to be narrowly interpreted.

### (1) First Embodiment

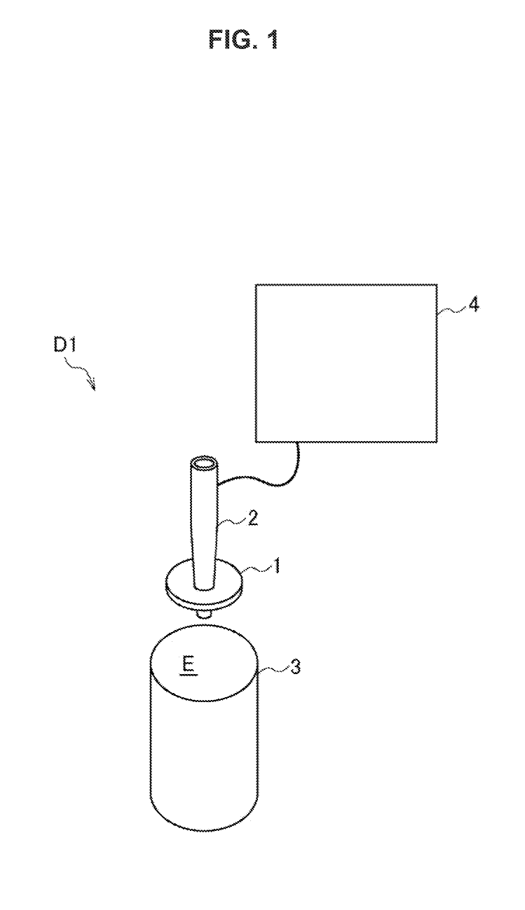

FIG. 1 schematically illustrates an example of a liquid agitation apparatus according to a first embodiment of the present disclosure. As illustrated in FIG. 1, a liquid agitation apparatus D1 includes a plate-like member for pipette tips 1 (hereinafter, also merely referred to as a plate-like member 1), a pipette tip 2 to be inserted into a pipette tip insertion hole 13 disposed to the plate-like member for pipette tips 1, a container 3 to contain a liquid discharged from the pipette tip 2, and a pipette controller 4 to control discharging of a liquid from the pipette tip 2. Hereinafter, each component of the liquid agitation apparatus D1 will be described with reference to FIGS. 1 to 8.

### <Plate-Like Member for Pipette Tips>

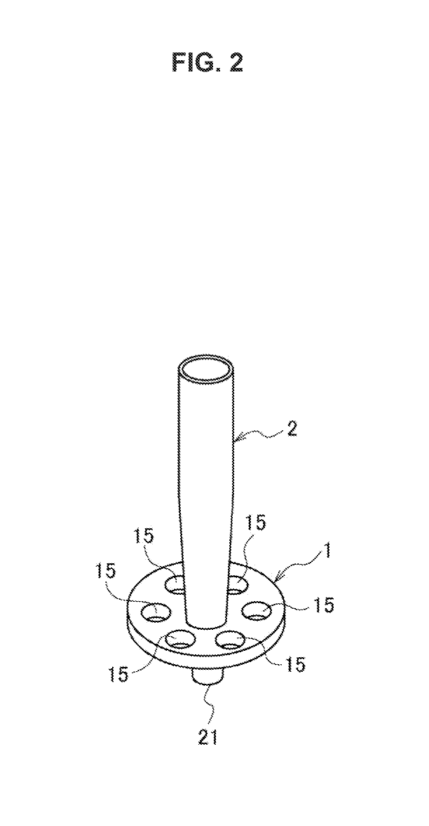

The plate-like member 1 is configured such that a flow rate of a liquid in the container 3 becomes non-uniform in an agitation action in the liquid agitation apparatus D1 described later, thereby to more effectively perform agitation. FIG. 2 is a perspective view of the pipette tip 2 provided with the plate-like member 1, seen from a first plane 11 side of the plate-like member 1. FIG. 2 also illustrates a state where the pipette tip 2 is inserted into the pipette tip insertion hole 13.

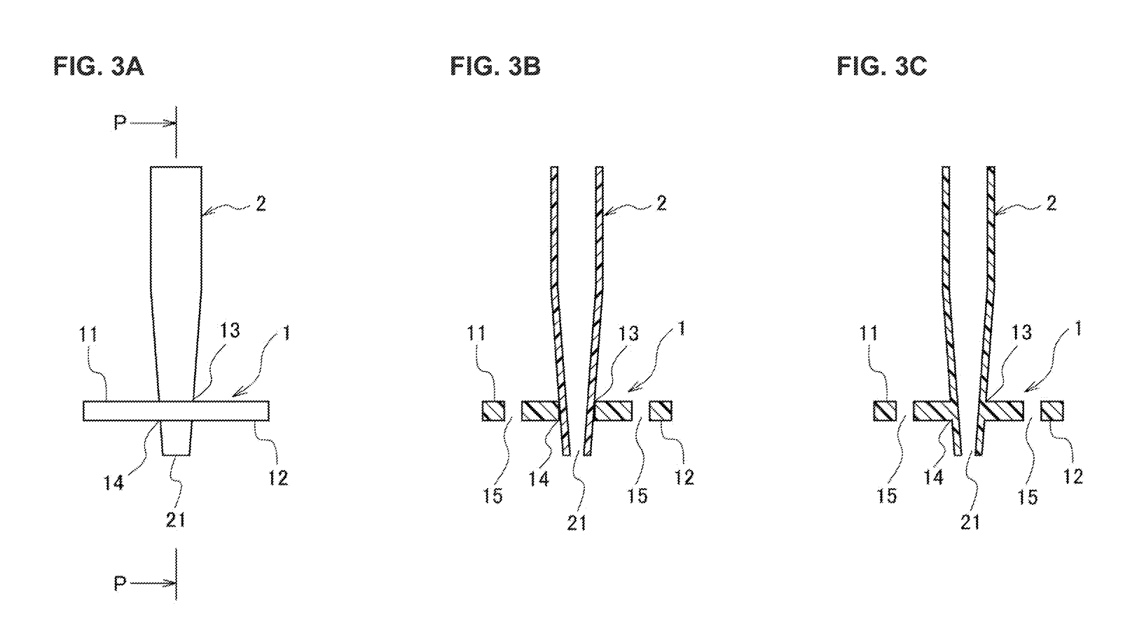

FIG. 3A is a plan view of the pipette tip 2 and the plate-like member 1. FIG. 3B is a cross-sectional diagram along P-P line of FIG. 3A. As illustrated in FIG. 2 and FIG. 3A, the plate-like member 1 includes the pipette tip insertion hole 13 disposed on the first plane 11, one or a plurality of communicating holes 14 that is disposed on a second plane 12 as a back face of the first plane 11 and communicates with the pipette tip insertion hole 13, one or a plurality of flow passages 15 through which a liquid discharged from the pipette tip 2 inserted into the pipette tip insertion hole 13 flows from the second plane 12 side to the first plane 11 side. In the plate-like member 1 illustrated in FIG. 3B, the pipette tip insertion hole 13 extends through the communicating hole 14 toward the second plane 12 side. Also, in a state where the pipette tip 2 is inserted into the pipette tip insertion hole 13, a pipette tip distal end 21 projects from the second plane 12.

The plate-like member 1 and the pipette tip 2 illustrated in FIG. 3B are separately formed. On the other hand, in the liquid agitation apparatus D1, the plate-like member 1 and the pipette tip 2 may be integrally molded (see FIG. 3C). When the plate-like member 1 and the pipette tip 2 are integrally molded, the work of inserting the pipette tip 2 into the pipette tip insertion hole 13 of the plate-like member 1 can be omitted, thereby improving workability. Furthermore, contamination of the pipette tip distal end 21 due to, for example, an erroneous touch on the pipette tip distal end 21 when attaching the plate-like member 1 to the pipette tip 2 can be inhibited.

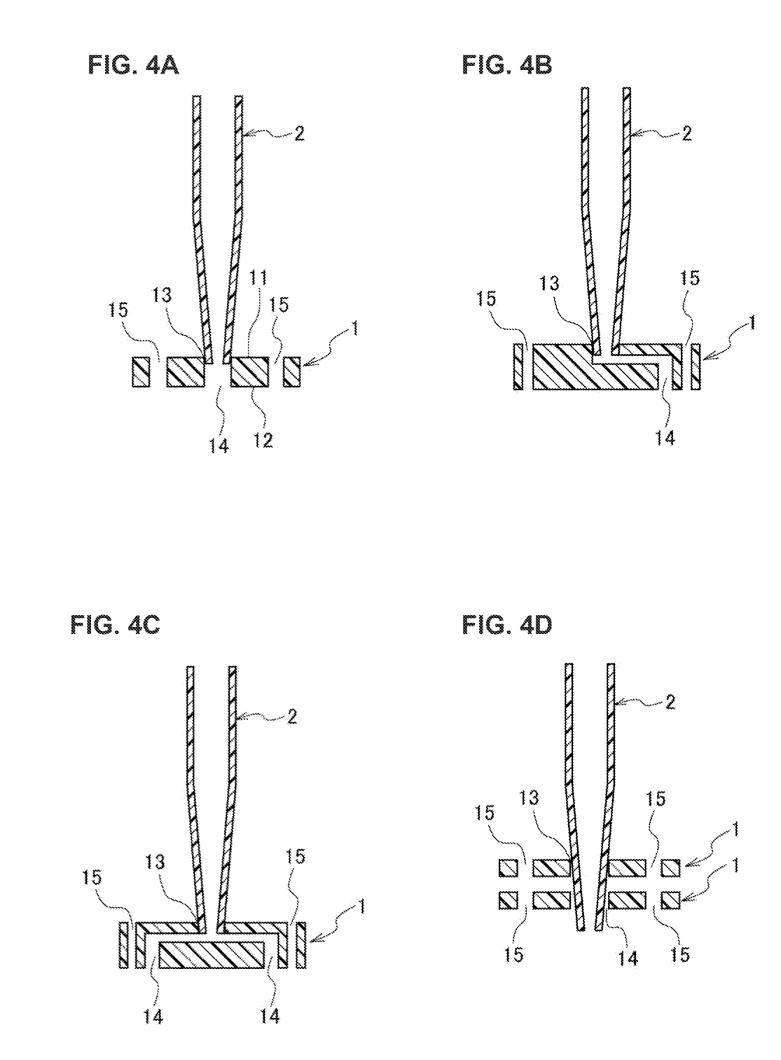

The pipette tip insertion hole 13 is not limited to the shapes illustrated in FIGS. 3A to 3C, as long as it is formed such that the pipette tip distal end 21, of the pipette tip 2, from which a liquid is discharged, can be inserted therein, and it communicates with the communicating holes 14. For example, as illustrated in FIG. 4A, the pipette tip insertion hole 13 may have a size that does not allow the pipette tip distal end 21 to project on the second plane 12 side in a state where the pipette tip distal end 21 is inserted therein. Also, as illustrated in FIG. 4B, a communicating portion between the pipette tip insertion hole 13 and the communicating hole 14 may have a bent portion. Other than this, the communicating portion may have a curved portion. Furthermore, as illustrated in FIG. 4C, the communication portion may have a branched portion. Also, in the liquid agitation apparatus D1, the effects in the agitation action described later are exerted when at least one plate-like member 1 is attached to the pipette tip 2. However, for example, as illustrated in FIG. 4D, a plurality of plate-like members 1 may be attached to the pipette tip 2, and the number of the plate-like members 1 is not limited.

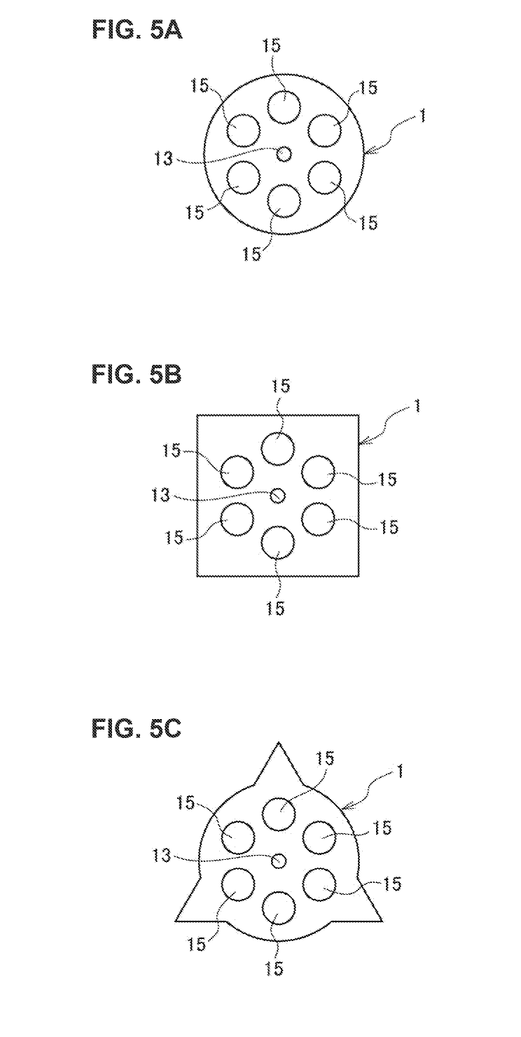

FIGS. 5A to 5C are each a schematic plan view illustrating a configuration example of the plate-like member 1. Although the pipette tip insertion hole 13 can be disposed in any position on the first plane 11, the pipette tip insertion hole 13 is preferably disposed in the center of the plate-like member 1 in a planar view. When disposed in the center of the plate-like member 1, a liquid can be agitated more uniformly in the action of agitating a liquid described later.

Although the shape of the plate-like member 1 may be a circle in a planar view as illustrated in FIG. 5A, the shape thereof is not limited, as long as it enables the action for agitating a liquid described later to be performed. For example, the plate-like member 1 may be a polygon like a square in a planar view (see FIG. 5B). The shape thereof may also be a combination of a polygon and a circle in a planar view (see FIG. 5C).

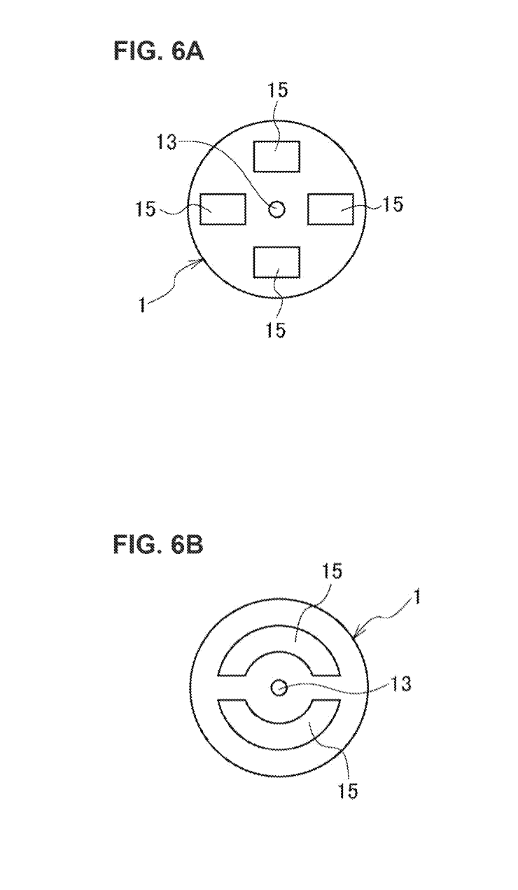

FIG. 6A and FIG. 6B are each a schematic plan view illustrating a configuration example of the plate-like member 1. Although the shape of an opening portion of the flow passage 15 disposed to the plate-like member 1 may be a circle in a planar view as illustrated in FIGS. 5A to 5C, the shape thereof is not limited as long as it enables the action for agitating a liquid described later to be performed. For example, as illustrated in FIG. 6A and FIG. 6B, the shape of the flow passage 15 may be a rectangle in a planar view, or may be curved. Furthermore, the opening portion of the flow passage 15 may have a varied shape on each of the first plane 11 side and the second plane 12 side.

Also, although the shape of the flow passage 15 is not limited as long as it allows a liquid discharged from the pipette tip 2 to flow from the second plane 12 side toward the first plane 11 side, the flow passage 15 may be a through hole (see FIG. 3B again). When forming the flow passage 15 as a through hole, the plate-like member 1 can be produced more simply compared to when the flow passage 15 has a branched shape.

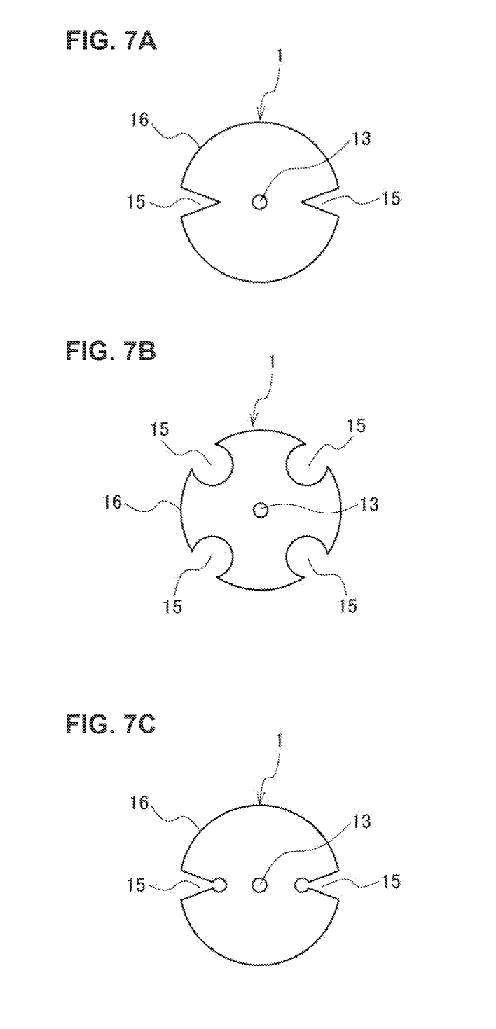

FIGS. 7A to 7C are each a schematic plan view illustrating a configuration example of the plate-like member 1. As illustrated in FIGS. 7A to 7C, the plate-like member 1 may have a notch on an edge 16 in a spreading direction of the plate-like member 1 with a shape of a polygon, a circle or a combination of a polygon and a circle. When the notch is provided to the plate-like member 1, a liquid discharged from the pipette tip 2 can flow from the second plane 12 side to the first plane 11 side in the plate-like member 1. That is, the notch can function as the flow passage 15. It is noted that both the through hole and the notch can also be provided to the plate-like member 1.

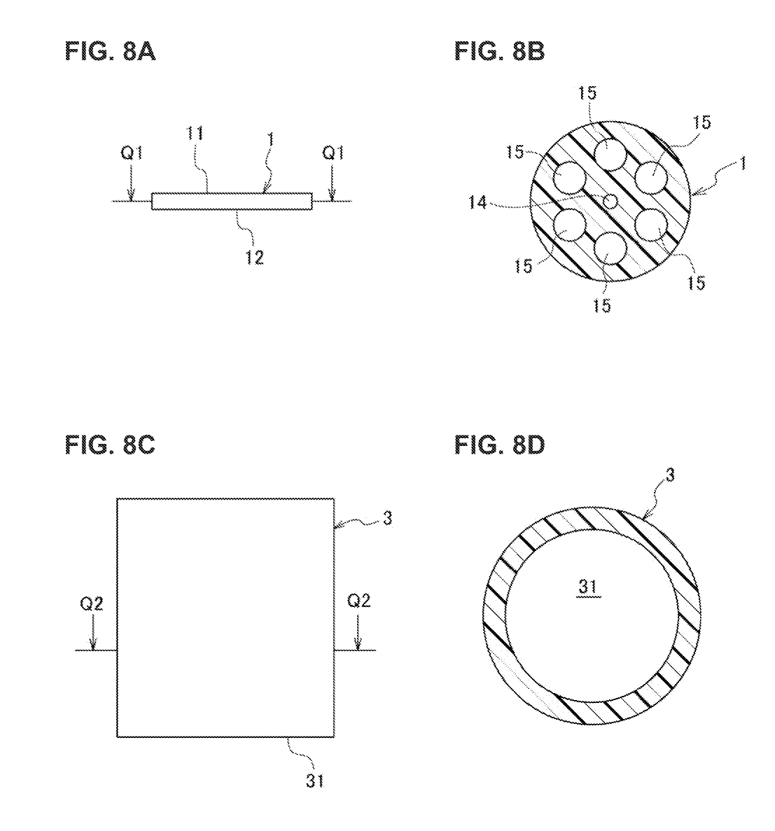

The size of the plate-like member 1 can be appropriately designed within the range in which the plate-like member 1 can be moved in and out of a space where a liquid is contained in the container 3, and the agitation action is not inhibited, in the action of agitating a liquid described later. Also, the plate-like member 1 preferably has a cross section similar to the cross section of the space where a liquid is contained in the container 3. An example of the cross section of the plate-like member 1 is a cross section (see FIG. 8B) along Q1-Q1 line in the case of the plate-like member 1 illustrated in FIG. 8A. Also, for example, it is a cross section vertical to a thickness direction of the plate-like member 1. An example of the cross section of the space where a liquid is contained is a cross section (see FIG. 8D) along Q2-Q2 line in the case of the container 3 illustrated in FIG. 8C. Also, for example, it is a cross section parallel to a container bottom 31, or a cross section vertical to a height direction of the container 3. When the plate-like member 1 has a cross section similar to the cross section of the space where a liquid is contained, agitation can be uniformly performed for the entire liquid in the action of agitating a liquid described later.

The material properties of the plate-like member 1 can be appropriately selected from known materials depending on the properties of the liquid to be agitated. Examples of the materials may include a polymer, copolymer, blend polymer or the like such as polypropylene, polymethyl methacrylate, polystyrene, acrylic resins, polysulfone, polytetrafluoroethylene, polyethylene, vinyl chloride, polyethylene terephthalate and polycarbonate. Also, plate materials formed from a plurality of types of materials may be bonded to each other, thereby to provide the plate-like member 1. Other than this, a mesh-like plate material may be used as the plate-like member 1. In this case, the mesh-like netting structure can function as the flow passages 15. Furthermore, for example, the plate-like member 1 may be subjected to surface treatment or the like for the purpose of reducing adsorption of substances contained in a liquid. Also, since the plate-like member 1 is a member that comes into contact with a liquid, it may be disposable (disposable use).

### <Pipette Tip>

The pipette tip 2 is configured to contain an optional volume of a liquid for a certain period of time and then discharge the liquid into the container 3, in the liquid agitation apparatus D1. In the liquid agitation apparatus D1 according to the first embodiment, the shape and material properties of the pipette tip 2 are not limited, as long as the pipette tip 2 can be attached with the plate-like member 1 and connected to the pipette controller 4, and can be moved in the container 3 to discharge a liquid from the pipette tip distal end 21 in the action of agitating a liquid described later. The pipette tip 2 may also be appropriately selected from conventionally known pipette tips, depending on the properties of the liquid to be agitated or the size of the container 3. Examples of the material of the pipette tip 2 may include a polymer, copolymer, blend polymer or the like such as polypropylene, polymethyl methacrylate, polystyrene, acrylic resins, polysulfone, polytetrafluoroethylene, polyethylene, vinyl chloride, polyethylene terephthalate and polycarbonate. The pipette tip 2 can also be designed as being disposable (disposable use), in a similar manner to known pipette tips.

### <Container>

The container 3 has a space E that contains a liquid in the agitation action described later, in the liquid agitation apparatus D1. The shape of the container 3 is not limited, as long as the pipette tip 2 attached with the plate-like member 1 can be moved in and out of the space E to exert the effects of the agitation described later, in the agitation action. The material properties of the container 3 can also be appropriately selected from known materials depending on the properties of the liquid to be agitated. Examples of the material of the container 3 may include a polymer, copolymer, blend polymer or the like such as polypropylene, polymethyl methacrylate, polystyrene, acrylic resins, polysulfone, polytetrafluoroethylene, polyethylene, vinyl chloride, polyethylene terephthalate and polycarbonate. The container 3 can also be designed as being disposable (disposable use), in a similar manner to the plate-like member 1 and the pipette tip 2.

The above-described plate-like member 1 and container 3 may be designed as a liquid agitation kit including the plate-like member 1 and the container 3 that contains a liquid discharged from the pipette tip 2. Also, there may be designed a liquid agitation kit including the plate-like member 1, the pipette tip 2 and the container 3.

The container 3 may be provided with a reagent or a sample to be mixed into a liquid discharged from the pipette tip 2. Also, the reagent or the sample can have any shape and volume, unless the action of agitating a liquid described later is not inhibited. For example, a reagent in a solid phase may be provided in the container 3.

The container 3 may be provided with members used for preservation of a liquid, processing of a liquid, analysis of a liquid, or the like, unless the action of agitating a liquid is inhibited. Examples of the members may include lids, filters and electrodes.

The composition of a liquid is not limited, as long as the liquid can be discharged from the pipette tip 2 and can be subjected to the agitation action. The liquid agitation apparatus Dl is suitably used for the liquid that contains at least one selected from, for example, cells, proteins, polysaccharides, alcohols, surfactants and synthetic polymers, from the reasons described later. The liquid may also be a biological sample. Examples of the biological sample may include body fluid such as whole blood, plasma, serum, cerebrospinal fluid, urine, semen and saliva.

In the liquid containing the above-described components, generation of high shear force during agitation may not be preferred in some cases. For example, cells, proteins and the like are contained in a biological sample. The activity of proteins may be changed under the influence of high shear force. Also, high shear force may damage cells, or change the properties of cells. Other than these, polymers such as polysaccharides, alcohols and synthetic polymers may also be cleaved under high shear force. The same applies to micelle-like surfactants.

### <Pipette Controller>

The pipette controller 4 is configured to control the previously-described discharging of a liquid from the pipette tip 2. The configuration of the pipette controller 4 is not limited, as long as an optional amount of a liquid can be discharged through the pipette tip 2 to the container 3. The configuration of the pipette controller 4 can be appropriately designed from the configurations of known pipetters, liquid dispensing apparatuses and the like. For example, the pipette controller 4 may be provided with a tip connection site, a plunger, a CPU and the like, and the CPU may control a movement amount of the plunger thereby to discharge an optional volume of a liquid from the pipette tip 2 connected to the tip connection site. Also, in order to agitate a liquid so as not to exceed the optional shear force, the pipette controller 4 preferably has a configuration for controlling a discharging rate of a liquid from the pipette tip 2. In this case, for example, the CPU may control a movement rate of the plunger. It is noted that a liquid discharged from the pipette tip 2 may be supplied from a tank or the like provided to the liquid agitation apparatus D1. Also, the pipette tip 2 may be introduced into a liquid retained in a sample tube or the like to suck the liquid (the tank and the sample tube are not illustrated in FIG. 1).

### (2) Method of Agitating Liquid

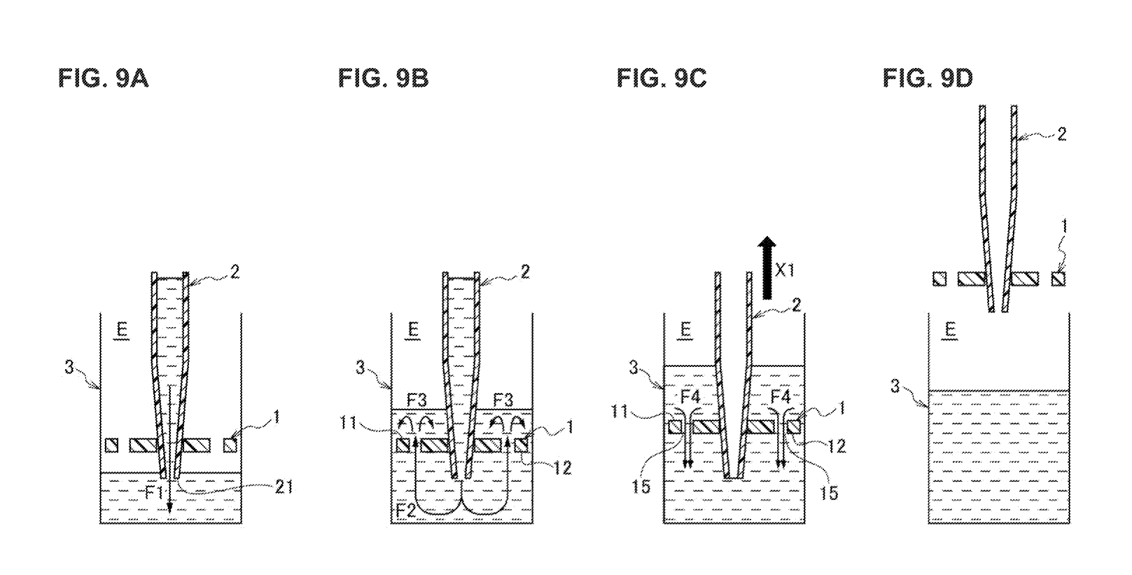

Hereinafter, a method of agitating a liquid according to the present disclosure will be described with reference to FIG. 9. That is, an action of agitating a liquid by the above-described liquid agitation apparatus D1 will be described.

FIG. 9A illustrates a state where a liquid is discharged from the pipette tip 2. When a liquid is discharged from the pipette tip 2 (see arrow F1), the liquid accumulates in the space E of the container 3 to raise a liquid level.

FIG. 9B illustrates a state where the liquid level has been raised to the height exceeding the plate-like member 1 attached to the pipette tip 2 in the container 3. As illustrated in FIG. 9B, the liquid discharged from the pipette tip 2 temporarily flows to a lower side of the container, and then flows upward (see arrow F2) to uniformly move upward until the liquid comes into contact with the plate-like member 1.

Since a part of the liquid flows through the flow passages 15 when the liquid has reached the second plane 12 of the plate-like member 1, the liquid reaches the first plane 11 side while the upward flow is not inhibited (see arrow F3). On the other hand, in a portion where the upward flow is inhibited by the plate-like member 1, the rising rate is suppressed. As a result, with respect to the rising rate that has been uniform, a portion having a high rising rate and a portion having a low rising rate are generated. This non-uniform rising rate of a liquid causes entrainment effects to be obtained thereby promoting agitation of a liquid.

In the plate-like member 1 described above, the pipette tip insertion hole 13 preferably extends through the communicating hole 14 toward the second plane 12 side. Furthermore, the inner diameter of the pipette tip insertion hole 13 is preferably formed with a size that allows the distal end of the pipette tip 2 (the pipette tip distal end 21) to project from the communicating hole 14 in a state where the pipette tip 2 is inserted (see FIG. 3B again). When the plate-like member 1 and the pipette tip 2 are configured as above, a liquid can be discharged to a position farther from the plate-like member 1, causing the non-uniformity in rate of a liquid in the second plane 12 to be more likely to be generated (see FIG. 9B).

FIG. 9C illustrates a state where the discharging of a liquid from the pipette tip 2 has been completed. When the pipette tip 2 is raised up in a direction indicated by arrow X1, the liquid residing on the first plane 11 side of the plate-like member 1 moves toward the second plane 12 side by gravity (see arrow F4). At this time, in a similar manner to when the liquid moves from the second plane 12 side to the first plane 11 side, the movement rate of the liquid becomes non-uniform by the plate-like member 1, thereby obtaining entrainment effects. As a result, agitation of a liquid is promoted. The raising-up of the pipette tip 2 is completed, and the action of agitating a liquid is also completed (see FIG. 9D). It is noted that the above-described action of agitating a liquid can also be manually performed by a user, while the pipette tip 2 provided with the plate-like member 1 is connected to a manual pipetter or the like.

Although the discharging of a liquid is performed once in the exemplary agitation method of a liquid illustrated in FIGS. 9A to 9D, the discharging and sucking of a liquid may be repeated two or more times in order to perform the agitation of a liquid more effectively. Also, for a reason similar to the above, the raising-up and pressing-down of the pipette tip 2 may be repeated two or more times after a liquid is discharged. It is noted that the plate-like member 1 to be raised up may be left in the container 3 unless a subsequent step performed to a liquid contained in the container 3 is hindered. An example of the subsequent step may include analysis of a liquid.

When the discharging rate of a liquid from the pipette tip 2 illustrated in FIG. 9A is determined within the range of not exceeding the shear stress limit of each liquid, unfavorable effects incurred on a liquid in the agitation action can be mitigated. When the shear force of a liquid discharged from the opening of the pipette tip distal end 21 is generated on the wall surface of the container 3 so that the discharged flow becomes a condition of laminar flow, the threshold average flow rate of a liquid discharged from the pipette tip 2 can also be calculated according to Mathematical formula (1) below.

u_{m,l}=8τₗd/μ (1)
u_{m,l}: Threshold average flow rate at opening of pipette tip distal end
τₗ: Shear stress limit
d: Diameter of opening of pipette tip distal end
μ: Viscosity coefficient of liquid

Also, since a liquid discharged from the pipette tip 2 flows through any one of the flow passages 15 disposed to the plate-like member 1, the average flow rate in the flow passages 15 can be calculated according to Mathematical formula (2) below. It is noted that when the opening of the flow passage 15 is not a perfect circle, like an ellipse or the like in a planar view, the diameter of the perfect circle having an identical area can be defined as diameter D of the flow passage 15.

u′ₘ=uₘd²/nD² (2)
u′ₘ: Average flow rate in flow passages
uₘ: Average flow rate at opening of pipette tip distal end
d: Diameter of opening of pipette tip distal end
n: Number of flow passages
D: Diameter of flow passages

Here, it is also necessary for the shear stress of the liquid passing through the plate-like member 1 to be not more than a shear stress limit. Therefore, a threshold average flow rate of the liquid passing though the flow passages 15 can also be calculated, for example, according to Mathematical Formula (3) below.

u′_{m,l}=8τₗD/μ (3)
u′_{m,l}: Threshold average flow rate in flow passages
τₗ: Shear stress limit
D: Diameter of flow passages
μ: Viscosity coefficient of liquid

In order to obtain maximum entrainment effects in the action of agitating a liquid both while being discharged from the pipette tip 2 and while passing through the plate-like member 1, the opening of the pipette tip distal end 21 and the flow passages 15 may be configured such that the above Mathematical formulas (1) to (3) are satisfied. Therefore, the relationship between the opening of the pipette tip distal end 21 and the flow passages 15 comes to be Mathematical formula (4) below.

d³=nD³ (4)
d: Diameter of opening of pipette tip distal end
n: Number of flow passages
D: Diameter of flow passages

In the liquid agitation apparatus according to the first embodiment described above, the pipette tip is provided with the plate-like member, thereby enabling the agitation of a liquid to be efficiently performed. For this reason, a liquid can be sufficiently agitated for a shorter period, compared to the conventional method of repeating the sucking into the pipette tip and the discharging from the pipette tip. For example, when a sample and a reagent which initiate reaction immediately after being mixed are mixed, a longer time taken for agitation causes unevenness to be generated such that reaction is initiated in a part of the liquid while reaction is not initiated in another part of the liquid. Such unevenness may lead to deterioration in accuracy in analysis or the like of a sample. Also, for example, when analysis or the like is performed after agitation has been performed until sufficient mixing state is obtained, it becomes difficult to analyze the state immediately after the initiation of reaction. The liquid agitation apparatus according to the present disclosure can efficiently perform agitation even when such a sample and reagent or the like are mixed, and thus is suitably used.

Also, when agitating a viscous liquid, the use of the conventional method of repeating sucking and discharging sometimes caused a longer time to be taken until a sufficiently mixed state was obtained, or sometimes inhibited sufficient agitation. The liquid agitation apparatus according to the first embodiment includes the plate-like member, thereby enabling even a liquid having viscosity to be agitated until a sufficiently mixed state is obtained.

When agitating a liquid, for example, a liquid can be discharged from an outlet having a reduced nozzle diameter to increase the flow rate of a liquid, thereby increasing the efficiency of agitation. However, in such a case, shear force becomes higher. On the other hand, since the liquid agitation apparatus according to the first embodiment agitates a liquid by generating unevenness in the flow rate of a liquid by the plate-like member, a liquid can be efficiently agitated while the shear force applied on a liquid is suppressed. For this reason, the liquid agitation apparatus according to the present disclosure is suitably used for the agitation of a liquid in which the shear force generated during agitation is preferably suppressed.

### (3) Second Embodiment

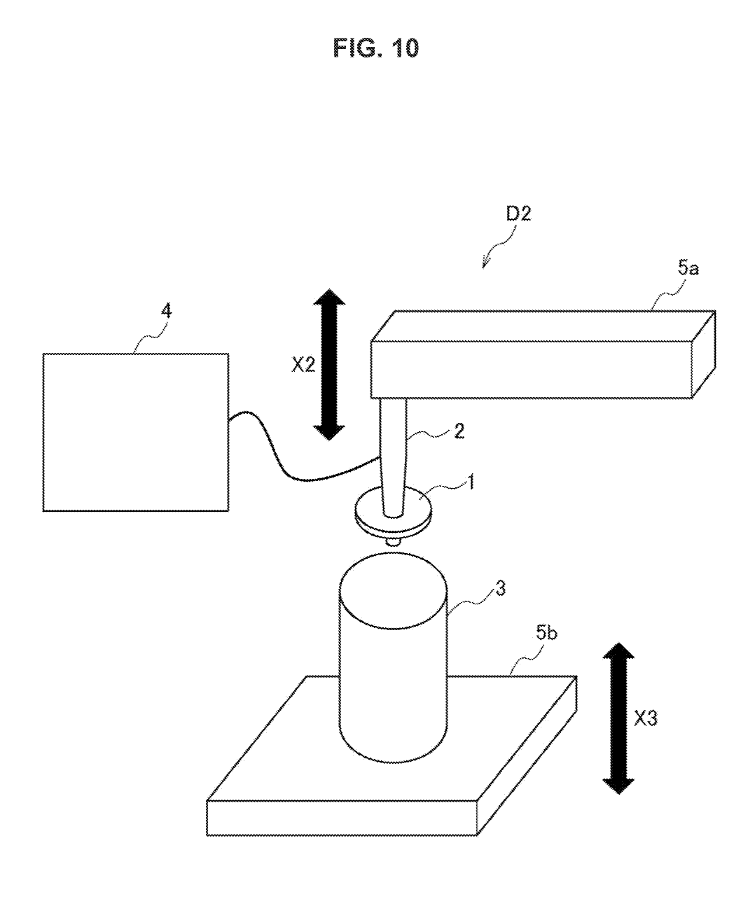

FIG. 10 is a schematic view illustrating an example of a liquid agitation apparatus according to a second embodiment of the present disclosure. In FIG. 10, a liquid agitation apparatus indicated by a reference numeral D2 includes a drive mechanism 5 (5a and 5b) that changes a relative position in the vertical direction between the pipette tip 2 and the container 3. It is noted that the same reference numerals are assigned to the same configurations as in the liquid agitation apparatus D1 according to the first embodiment, and description thereof will be omitted.

The configuration of the drive mechanism 5 (5a and 5b) is not limited as long as it enables the relative position in the vertical direction between the pipette tip 2 and the container 3 to be changed. The drive mechanism 5 (5a and 5b) can be appropriately designed from the configurations of known liquid dispensers. The drive mechanism 5 may have a configuration (5a) in which, for example, a position of the pipette tip 2 in the vertical direction is changed as indicated by arrow X2. Also, the drive mechanism 5 may have a configuration (5b) in which a position of the container 3 in the vertical direction is changed as indicated by arrow X3. It is noted that the liquid agitation apparatus D2 may include the drive mechanisms 5a and 5b for both the pipette tip 2 and the container 3 respectively.

Since the liquid agitation apparatus according to the second embodiment includes the drive mechanism that changes the relative position in the vertical direction between the pipette tip and the container, the plate-like member can be raised up from the container at an optional rate. For this reason, the state of a liquid after the agitation action performed by the plate-like member becomes more uniform among a plurality of liquid samples, thereby achieving highly accurate analysis of a liquid after agitation or the like. Other effects by the liquid agitation apparatus according to the second embodiment are similar to those by the above-described liquid agitation apparatus according to the first embodiment.

It is noted that the above-described effects are merely exemplary, and not limiting. Other effects may also exist.

Additionally, the present technology may also be configured as below.

(1) A plate-like member for pipette tips including:
a pipette tip insertion hole disposed on a first plane;
one or a plurality of communicating holes that is disposed on a second plane as a back face of the first plane and that communicates with the pipette tip insertion hole; and
one or a plurality of flow passages through which a liquid discharged from a pipette tip inserted into the pipette tip insertion hole flows from the second plane side to the first plane side.

(2) The plate-like member for pipette tips according to (1), wherein the pipette tip insertion hole extends through the communicating holes to the second plane side.

(3) The plate-like member for pipette tips according to (1) or (2), wherein the pipette tip insertion hole is disposed in a center in a planar view.

(4) The plate-like member for pipette tips according to any one of (1) to (3), wherein the flow passages are through holes.

(5) The plate-like member for pipette tips according to any one of (1) to (4), wherein an edge is notched in a spreading direction of the plate-like member for pipette tips with a shape of a polygon, a circle or a combination of a polygon and a circle.

(6) The plate-like member for pipette tips according to any one of (1) to (5), wherein the liquid contains at least one selected from cells, proteins, polysaccharides, alcohols, surfactants and synthetic polymers.

(7) The plate-like member for pipette tips according to (6), wherein the liquid is a biological sample.

(8) A pipette tip including the plate-like member for pipette tips according to any one of (1) to (7).

(9) The pipette tip according to (8), wherein an inner diameter of the pipette tip insertion hole is formed with a size that allows a distal end of the pipette tip to project from the communicating hole in a state where the pipette tip is inserted.

(10) The pipette tip according to (8) or (9), wherein the plate-like member for pipette tips and the pipette tip are integrally molded.

(11) A liquid agitation kit including:
the plate-like member for pipette tips according to any one of (1) to (7); and
a container that contains a liquid discharged from the pipette tip.

(12) The liquid agitation kit according to (11), wherein the plate-like member for pipette tips has a cross section similar to a cross section of a space where the liquid is contained in the container.

(13) A liquid agitation apparatus including:
the plate-like member for pipette tips according to any one of (1) to (7);
a pipette tip that is inserted into the pipette tip insertion hole;
a container that contains a liquid discharged from the pipette tip; and
a pipette controller that controls discharging of the liquid from the pipette tip.

(14) The liquid agitation apparatus according to (13), further including a drive mechanism that changes a relative position in a vertical direction between the pipette tip and the container.

What is claimed is:

1. A plate-like member for pipette tips comprising:
a pipette tip insertion hole disposed on a first plane;
one or a plurality of communicating holes that is disposed on a second plane as a back face of the first plane and that communicates with the pipette tip insertion hole; and
one or a plurality of flow passages through which a liquid discharged from a pipette tip inserted into the pipette tip insertion hole flows from the second plane side to the first plane side.

2. The plate-like member for pipette tips according to claim 1, wherein the pipette tip insertion hole extends through the communicating holes to the second plane side.

3. The plate-like member for pipette tips according to claim 1, wherein the pipette tip insertion hole is disposed in a center in a planar view.

4. The plate-like member for pipette tips according to claim 1, wherein the flow passages are through holes.

5. The plate-like member for pipette tips according to claim 1, wherein an edge is notched in a spreading direction of the plate-like member for pipette tips with a shape of a polygon, a circle or a combination of a polygon and a circle.

6. The plate-like member for pipette tips according to claim 1, wherein the liquid contains at least one selected from cells, proteins, polysaccharides, alcohols, surfactants and synthetic polymers.

7. The plate-like member for pipette tips according to claim 6, wherein the liquid is a biological sample.

8. A pipette tip including the plate-like member for pipette tips according to claim 1.

9. The pipette tip according to claim 8, wherein an inner diameter of the pipette tip insertion hole is formed with a size that allows a distal end of the pipette tip to project from the communicating hole in a state where the pipette tip is inserted.

10. The pipette tip according to claim 8, wherein the plate-like member for pipette tips and the pipette tip are integrally molded.

11. A liquid agitation kit comprising:
the plate-like member for pipette tips according to claim 1; and
a container that contains a liquid discharged from the pipette tip.

12. The liquid agitation kit according to claim 11, wherein the plate-like member for pipette tips has a cross section similar to a cross section of a space where the liquid is contained in the container.

13. A liquid agitation apparatus comprising:
the plate-like member for pipette tips according to claim 1;
a pipette tip that is inserted into the pipette tip insertion hole;
a container that contains a liquid discharged from the pipette tip; and
a pipette controller that controls discharging of the liquid from the pipette tip.

14. The liquid agitation apparatus according to claim 13, further comprising a drive mechanism that changes a relative position in a vertical direction between the pipette tip and the container.
